(19) United States
(12) Patent Application Publication
(10) Pub. No.: US 2026/0237999 A1
(43) Pub. Date: Aug. 13, 2026

(54) POWER DISTRIBUTION DEVICE

(71) Applicants: DENSO ELECTRONICS CORPORATION, Anjo-city (JP); DENSO CORPORATION, Kariys-city (JP)

(72) Inventors: Naoyuki YASUDA, Anjo-city (JP); Shigekazu SUGIMOTO, Anjo-city (JP); Yoshifumi KISHIMOTO, Kariys-city (JP); Noriaki OKADA, Kariys-city (JP); Keisuke SANDA, Kariys-city (JP); Akimitsu INOUE, Kariys-city (JP); Jun FUKUHARA, Kariys-city (JP)

(21) Appl. No.: 19/645,658

(22) Filed: Apr. 13, 2026

Related U.S. Application Data
(63) Continuation of application No. PCT/JP2024/036133, filed on Oct. 9, 2024.

(30) Foreign Application Priority Data
Oct. 31, 2023 (JP) 2023-186930

(51) Int. Cl. H02H 7/22

(52) U.S. Cl. CPC H02H 7/22

(57) ABSTRACT

A device includes a first system conductor supplying a first load from a first power source, a second system conductor supplying a second load from a second power source, and an inter-system conductor supplies the first power source to the second load or the second power source to the first load. First and second series-connected switches share a common connection terminal coupled to ground through a resistive element. A circuit measures first, second, and third voltages of the first system conductor, the second system conductor, and the common connection terminal, respectively, to ground; determines a conduction fault of at least one switch based on whether the first and/or second voltage differs from the third voltage under switch on/off states; and determines a cutoff fault based on whether the third voltage is at least a threshold value.

### CROSS REFERENCE TO RELATED APPLICATIONS

The present application is a continuation application of International Patent Application No. PCT/JP2024/036133 filed on Oct. 9, 2024, which designated the U.S. and claims the benefit of priority from Japanese Patent Application No. 2023-186930 filed on Oct. 31, 2023. The entire disclosures of all of the above applications are incorporated herein by reference.

### TECHNICAL FIELD

The present disclosure relates to a power distribution device.

### BACKGROUND

A power distribution device may include a first system bus for transmitting power supplied from a first power source to a first load, and a second system bus for transmitting power supplied from a second power source to a second load.

### SUMMARY

According to an aspect of the present disclosure, a power distribution device includes a first system conductor, a second system conductor, an inter-system conductor, a first switch, a second switch, a resistive element, and a circuit. The first system conductor supplies power output from a first power source to a first load. The second system conductor supplies power output from a second power source to a second load. The inter-system conductor is located between the first system conductor and the second system conductor. The inter-system conductor supplies power output from the first power source through the first system conductor to the second load, or supplies power output from the second power source through the second system conductor to the first load. The first switch is located between the first system conductor and the second system conductor. The first switch is turned on to conduct current flowing through the inter-system conductor, and is turned off to cut off current flowing through the inter-system conductor. The second switch is located between the first system conductor and the second system conductor. The second switch is turned on to conduct current flowing through the inter-system conductor, and is turned off to cut off current flowing through the inter-system conductor. The resistive element is connected between a ground and a common connection terminal to which the first switch and the second switch are commonly connected. When the first switch is turned on and the second switch is turned off, the circuit may determine whether a conduction function of the first switch is faulty based on whether a first voltage differs from a third voltage. The first voltage is a voltage between the first system conductor and the ground; a second voltage is a voltage between the second system conductor and the ground; and the third voltage is a voltage between the common connection terminal and the ground. When the first switch is turned off and the second switch is turned on, the circuit may determine whether a conduction function of the second switch is faulty based on whether the second voltage differs from the third voltage. When the first switch and the second switch are turned on, the circuit may determine whether the conduction function of at least one of the first switch or the second switch is faulty based on whether at least one of the first voltage or the second voltage differs from the third voltage. When the first switch and the second switch are turned off, the circuit may determine a cutoff function of at least one of the first switch or the second switch is faulty based on whether the third voltage is at least a threshold value.

### BRIEF DESCRIPTION OF DRAWINGS

FIG. 1 is a diagram showing an electrical circuit configuration of an in-vehicle power supply system according to an embodiment of the present disclosure.

FIG. 2 is a chart showing, for each of the four fault diagnoses performed by the diagnostic circuit in the above-mentioned embodiment, the ON/OFF states of two switches, the output voltage of a first system conductor, the output voltage of a second system conductor, and the output voltage of a common connection terminal.

FIG. 3 is a flowchart showing the details of normal diagnostic processing performed by the diagnostic circuit in the above-mentioned embodiment of FIG. 1.

FIG. 4 is a flowchart showing the details of self-diagnosis processing performed by the diagnostic circuit in the above-mentioned embodiment of FIG. 1.

FIG. 5 is a diagram showing an electrical circuit configuration of an in-vehicle power supply system in a first comparative example of the above-mentioned embodiment.

FIG. 6 is a diagram showing an electrical circuit configuration of an in-vehicle power supply system in a second comparative example of the above-mentioned embodiment.

### DETAILED DESCRIPTION

A power supply system may include: an inter-system bus that electrically connects the first system bus and the second system bus; and a first switch and a second switch that are connected in series between the first system bus and the second system bus to switch between conduction and cutoff of current in the inter-system bus. In addition, the power supply system includes a resistive element disposed between the first switch and the second switch, which is connected in series to the first switch and the second switch between the first system bus and the second system bus.

The resistive element may be used by the control unit to detect the inter-system current value, which is the magnitude of the current flowing through the inter-system bus. Further, the first switch and the second switch, together with the resistive element, form a cutoff circuit.

The control unit, when the discharge current value, which is the magnitude of the current discharged from the second power supply, rises above the over-discharge threshold, may determine that a ground fault has occurred and controls the first switch and the second switch to the cutoff state. The control unit changes the over-discharge threshold to a lower value when the inter-system current value is smaller than a predetermined threshold.

The inventors in the present application considered performing fault diagnosis of the first switch and second switch of the cutoff circuit in the above-mentioned power distribution device.

With the control unit turning on both the first switch and the second switch, the inter-system current value flowing through the resistive element is obtained, and it is determined whether this obtained inter-system current value is equal to or greater than the threshold value. As a result, it is possible to determine whether the first switch and the second switch are each turned on normally.

However, if a large current flows as the inter-system current value through the resistive element, the resistive element generates a large amount of heat. Therefore, it becomes necessary to increase the heat dissipation performance of the resistive element, and consequently, the heat dissipation performance of the cutoff circuit.

According to an aspect of the present disclosure, a power distribution device includes a first system conductor, a second system conductor, an inter-system conductor, a first switch, a second switch, a resistive element, a first determination unit, a second determination unit, a third determination unit, and a fourth determination unit. The first system conductor supplies power output from a first power source to a first load. The second system conductor supplies power output from a second power source to a second load. The inter-system conductor is located between the first system conductor and the second system conductor. The inter-system conductor supplies power output from the first power source through the first system conductor to the second load, or supplies power output from the second power source through the second system conductor to the first load. The first switch is located between the first system conductor and the second system conductor. The first switch is turned on to conduct a current flowing through the inter-system conductor, and is turned off to cut off the current flowing through the inter-system conductor. The second switch is located between the first system conductor and the second system conductor. The second switch is turned on to conduct the current flowing through the inter-system conductor, and is turned off to cut off the current flowing through the inter-system conductor. The resistive element is connected between a ground and a common connection terminal to which the first switch and the second switch are commonly connected. When the first switch is turned on and the second switch is turned off, the first determination unit may determine whether a conduction function of the first switch is faulty based on whether a first voltage differs from a third voltage. The first voltage is a voltage between the first system conductor and the ground; a second voltage is a voltage between the second system conductor and the ground; and the third voltage is a voltage between the common connection terminal and the ground. When the first switch is turned off and the second switch is turned on, the second determination unit may determine whether a conduction function of the second switch is faulty based on whether the second voltage differs from the third voltage. When the first switch and the second switch are turned off, the third determination unit may determine whether the conduction function of at least one of the first switch or the second switch is faulty based on whether at least one of the first voltage or the second voltage differs from the third voltage. When the first switch and the second switch are turned on, the fourth determination unit may determine a cutoff function of at least one of the first switch or the second switch is faulty based on whether the third voltage is at least a threshold value.

As described above, it is possible to provide a power distribution device that performs fault diagnosis of the first switch and the second switch without detecting current using a resistive element.

The following will describe embodiments of the present disclosure with reference to the drawings. In the following embodiments, portions that are identical or equivalent to each other are denoted by the same reference numerals in the drawings to simplify the description.

### First Embodiment

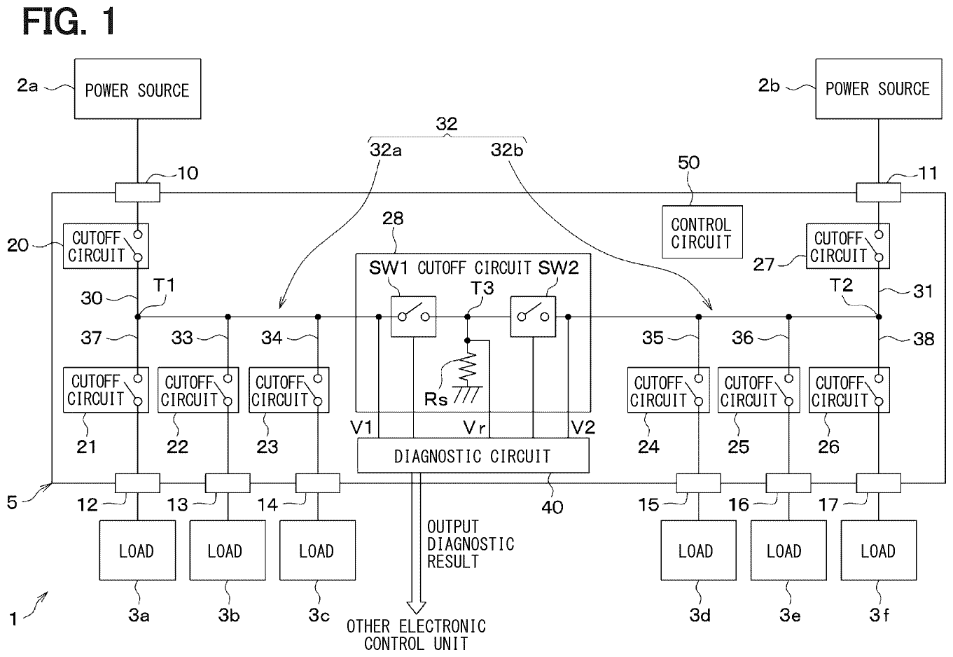

FIG. 1 shows an embodiment of an in-vehicle power supply system 1 according to the present disclosure. In this embodiment, the in-vehicle power supply system 1 supplies electric power from power sources 2a and 2b to loads 3a, 3b, 3c, 3d, 3e, and 3f.

Specifically, the in-vehicle power supply system 1 includes the power sources 2a and 2b, the loads 3a, 3b, 3c, 3d, 3e, and 3f, as well as an electronic control unit 5.

The power sources 2a and 2b are each direct current (DC) power sources installed in a vehicle and generate DC power. In this embodiment, the power source 2a is, for example, a first power source configured by a secondary battery that outputs a supply voltage.

The power source 2b is a second power source configured by a DC-DC converter that steps down the output voltage of a high-voltage power source and outputs the output voltage. The high-voltage power source has an output voltage that is higher than the output voltage of the above-mentioned secondary battery.

The loads 3a, 3b, 3c, 3d, 3e, and 3f are each electrical loads installed in the vehicle and operated by the direct current power supplied from the power sources 2a and 2b. The electronic control unit 5 forms a power distribution device that distributes the DC power supplied from the power sources 2a and 2b to the loads 3a, 3b, 3c, 3d, 3e, and 3f.

The electronic control unit 5 is provided with connectors 10, 11, 12, 13, 14, 15, 16, and 17; cutoff circuits 20, 21, 22, 23, 24, 25, 26, 27, and 28; system conductors 30 and 31; and an inter-system conductor 32. The electronic control unit 5 is provided with branch conductors 33, 34, 35, 36, 37, and 38; a diagnostic circuit 40; and a control circuit 50.

The connector 10 is connected to the positive terminal of the power source 2a. The negative terminal of the power source 2a is connected to ground. The connector 11 is connected to the positive terminal of the power source 2b. The negative terminal of the power source 2b is connected to ground.

The connector 12 is connected to the positive terminal of the load 3a. The negative terminal of the load 3a is connected to ground. The connector 13 is connected to the positive terminal of the load 3b. The negative terminal of the load 3b is connected to ground. The connector 14 is connected to the positive terminal of the load 3c. The negative terminal of the load 3c is connected to ground.

The connector 15 is connected to the positive terminal of the load 3d. The negative terminal of the load 3d is connected to ground. The connector 16 is connected to the positive terminal of the load 3e. The negative terminal of the load 3e is connected to ground. The connector 17 is connected to the positive terminal of the load 3f. The negative terminal of the load 3f is connected to ground.

The cutoff circuit 20 is arranged in the system conductor 30 and is a switch that is turned on to conduct a current flowing through the system conductor 30, and is turned off to cut off the current flowing through the system conductor 30. The system conductor 30 is a first system conductor mainly for supplying the DC power output from the power source 2a to the loads 3a, 3b, and 3c, that is, to the first load. The system conductor 30 is connected between the connector 10 and the connectors 12, 13, and 14.

The system conductor 30 according to the present embodiment is made of, for example, conductive metal components or conductive patterns on a circuit board. The common connection terminal T1 is a terminal to which the system conductor 30, the inter-system conductor 32, and the branch conductor 37 are commonly connected.

The branch conductor 37 is disposed between the system conductor 30 and the connector 12. The inter-system conductor 32 is disposed between the system conductor 30 and the system conductor 31.

The inter-system conductor 32 serves the role of supplying the DC power output from the power source 2a through the system conductor 30 to loads 3d, 3e, and 3f, or supplying the DC power output from the power source 2b through the system conductor 31 to loads 3a, 3b, and 3c.

The inter-system conductor 32 according to the present embodiment is made of, for example, of a conductive metal component or a conductive pattern on a circuit board. The cutoff circuit 21 is a switch disposed in the branch conductor 37. The switch turns on and off to conduct or cut off the current flowing through the branch conductor 37.

The cutoff circuit 27 is disposed in the system conductor 31, and is a switch that turns on to conduct a current flowing through the system conductor 31 and turns off to cutoff the current flowing through the system conductor 31. The system conductor 31 is a second system conductor for mainly supplying the DC power output from the power source 2b to the loads 3d, 3e, and 3f, that is, to the second loads. The system conductor 31 is connected between the connector 11 and the connectors 15, 16, and 17.

In the present embodiment, the system conductor 31 is made of, for example, a conductive metal component or a conductive pattern on a circuit board. The common connection terminal T2 is a terminal to which the system conductor 31, the inter-system conductor 32, and the branch conductor 38 are commonly connected.

The branch conductor 38 is disposed between the system conductor 31 and the connector 17. The cutoff circuit 26 is a switch arranged in the branch conductor 38. The switch turns on and off to conduct or cut off the current flowing through the branch conductor 38.

The cutoff circuit 22 is a switch that turns on and off to conduct or cut off the current flowing through the branch conductor 33. The branch conductor 33 is a conductive part that connects the first main conductor 32a and the connector 13. The first main conductor 32a is a conductive part that occupies the portion of the inter-system conductor 32 between the cutoff circuit 28 and the common connection terminal T1.

The cutoff circuit 23 is a switch that switches the conduction and cutoff of the current flowing through the branch conductor 34 by turning on and off the switch. The branch conductor 34 is a conductive part that connects the first main conductor 32a and the connector 14. The cutoff circuit 24 is a switch that turns on and off to conduct or cut off the current flowing through the branch conductor 35.

The branch conductor 35 is a conductor that connects the second main conductor 32b and the connector 15. The second main conductor 32b is a conductor that occupies the portion of the inter-system conductor 32 between the cutoff circuit 28 and the common connection terminal T2.

The cutoff circuit 25 is a switch that is turned on to conduct a current flowing through the branch conductor 36, and is turned off to cut off the current flowing through the branch conductor 36. The branch conductor 36 is a conductive part that connects the second main conductor 32b and the connector 16. In this embodiment, the cutoff circuits 20, 21, 22, 23, 24, 25, 26, and 27 are each turned on and off by the control circuit 50.

In this embodiment, the branch conductors 33, 34, 35, 36, 37, and 38 are each made of, for example, a conductive metal component or a conductive pattern of a circuit board. The cutoff circuit 28 includes switches SW1, SW2, and a resistive element Rs.

The switch SW1 is a first switch disposed between the system conductors 30 and 31. The switch SW2 is a second switch disposed between the system conductors 30 and 31, and is connected in series with the switch SW1. The switch SW2 is disposed on the common connection terminal T2 side relative to the switch SW1.

In other words, the switches SW1 and SW2 are respectively disposed between the first main conductor 32a and the second main conductor 32b. The switches SW1 and SW2 are each connected in series with the inter-system conductor 32. The switches SW1 and SW2, by being turned on or off, connect or disconnect the system conductors 30 and 31.

As a result, each of the switches SW1 and SW2 turns on to conduct the current flowing through the inter-system conductor 32, and turns off to cut off the current flowing through the inter-system conductor 32. The resistive element Rs is connected between the common connection terminal T3 and ground.

Here, in order to supply the output power of the power source 2a to the loads 3d, 3e, and 3f through the inter-system conductor 32, or to supply the output power of the power source 2b to the loads 3a, 3b, and 3c through the inter-system conductor 32, the resistance value of the resistive element Rs is set to a large value.

The resistive element Rs in the present embodiment serves to bring the potential of the common connection terminal T3 to the same potential as ground when the switches SW1 and SW2 are turned off. The resistive element Rs is used to detect a fault in the switches SW1 and SW2. The common connection terminal T3 is a terminal that is disposed between switches SW1 and SW2, and to which both the switches SW1 and SW2 are commonly connected.

In the present embodiment, the cutoff circuits 20, 21, 22, 23, 24, 25, 26, and 27 include mechanical relay switches or semiconductor switches. Further, the switches SW1 and SW2 include mechanical relay switches or semiconductor switches.

In the present embodiment, the voltage V1 is a first voltage between the first main conductor 32a of the inter-system conductor 32 and ground. Therefore, the voltage V1 becomes the voltage between the system conductor 30 and ground.

The voltage V2 is a second voltage between the second main conductor 32b of the inter-system conductor 32 and ground. Therefore, the voltage V2 becomes the voltage between the system conductor 31 and ground. The voltage Vr is a third voltage between the common connection terminal T3 and ground.

The diagnostic circuit 40 includes a memory, a microcomputer, and the like. The diagnostic circuit 40 executes a normal diagnostic processing in accordance with the execution of a computer program. The normal diagnostic processing is repeatedly performed during normal operation of the in-vehicle power supply system 1.

The diagnostic circuit 40, in executing a normal diagnostic processing, performs fault diagnosis of the switches SW1 and SW2 based on the voltages V1, V2, and Vr, with the switches SW1 and SW2 being turned on.

The diagnostic circuit 40 executes a self-diagnosis processing in accordance with the execution of the computer program. The self-diagnosis processing is executed when the vehicle is not in operation, for example, when the main power supply of the vehicle is being turned off.

When the self-diagnosis processing is performed, the diagnostic circuit 40 performs a fault diagnosis of the power sources 2a, 2b and the switches SW1, SW2 based on the voltages V1, V2, and Vr, with the switches SW1, SW2 turned on or off. The control circuit 50 turns on or off each of the cutoff circuits 20, 21, 22, 23, 24, 25, 26, and 27.

Next, the operation of the in-vehicle power supply system 1 according to the present embodiment will be described.

During normal operation, the control circuit 50 turns on each of the cutoff circuits 20, 21, 22, 23, 24, 25, 26, and 27.

At this time, the power source 2a and the load 3a are connected through the cutoff circuits 20 and 21, the connectors 10 and 12, the system conductor 30, and the branch conductor 37. The first main conductor 32a of the inter-system conductor 32 and the load 3b are connected through the cutoff circuit 22, the connector 13, and the branch conductor 33.

The first main conductor 32a of the inter-system conductor 32 and the load 3c are connected through the cutoff circuit 23, the connector 14, and the branch conductor 34. The power source 2b and the load 3f are connected through the cutoff circuits 27 and 26, the connectors 11 and 17, the system conductor 31, and the branch conductor 38.

The second main conductor 32b of the inter-system conductor 32 and the load 3e are connected through the cutoff circuit 25, the connector 16, and the branch conductor 36. The second main conductor 32b of the inter-system conductor 32 and the load 3d are connected through the cutoff circuit 24, the connector 15, and the branch conductor 35.

At this time, the DC power output from the power source 2a through the system conductor 30 is supplied to the loads 3a, 3b, and 3c. The DC power output from the power source 2b through the system conductor 31 is supplied to the loads 3d, 3e, and 3f.

The diagnostic circuit 40 turns on the switches SW1 and SW2 of the cutoff circuit 28, respectively. At this time, the system conductors 30 and 31 are connected through the inter-system conductor 32 and the switches SW1 and SW2. For example, when the output voltage of the power source 2a is higher than the output voltage of the power source 2b, the voltages V1, V2, and Vr become equal to the output voltage of the power source 2a.

Accordingly, the current flows from the power source 2a through the system conductor 30, the common connection terminal T1, the inter-system conductor 32, and the switches SW1 and SW2 toward the common connection terminal T2 side. At this time, the magnitude of the current flowing through the cutoff circuit 28 from the first main conductor 32a to the second main conductor 32b is determined by the loads 3d, 3e, and 3f.

As a result, the DC power output from the power source 2a through the system conductor 30 is supplied to the loads 3d, 3e, and 3f through the inter-system conductor 32 and the switches SW1 and SW2.

On the other hand, when the output voltage of the power source 2b is higher than the output voltage of the power source 2a, the voltages V1, V2, and Vr become equal to the output voltage of the power source 2b.

Accordingly, the current flows from the power source 2b through the system conductor 31, the common connection terminal T2, the inter-system conductor 32, and the switches SW1 and SW2 toward the common connection terminal T1 side. At this time, the magnitude of the current flowing through the cutoff circuit 28 from the second main conductor 32b to the first main conductor 32a is determined by the loads 3a, 3b, and 3c.

As a result, the DC power output from the power source 2b through the inter-system conductor 32 is supplied to the loads 3a, 3b, and 3c through the system conductor 31 and the switches SW1 and SW2.

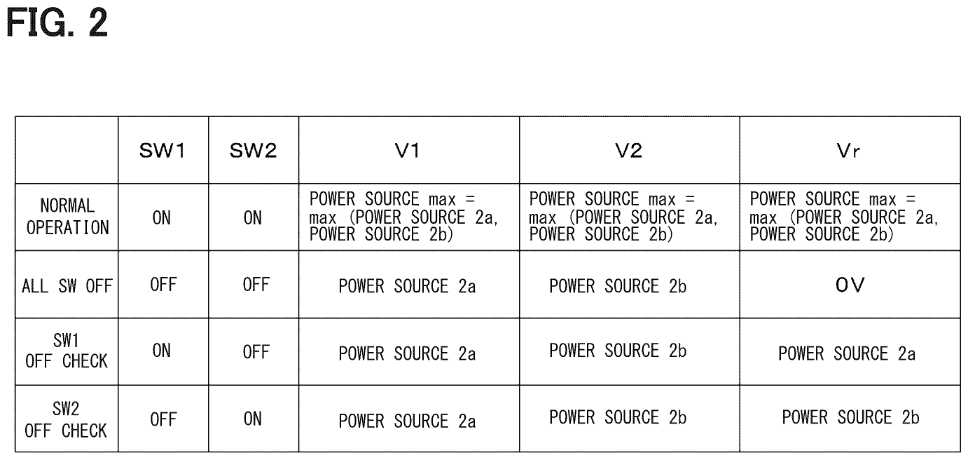

In this case, as shown in FIG. 2, if the power source max outputs the larger one of the output voltages of the power source 2a and the power source 2b, the voltages V1, V2, and Vr will each be the same voltage as the output voltage of power source max.

In this way, during normal operation, the loads 3a, 3b, 3c, 3d, 3e, and 3f are each supplied with DC power from at least one of the power sources 2a or 2b and operate accordingly.

At this time, in order to restrict the DC power output from the power sources 2a and 2b from being output to ground via the common connection terminal T3 and the resistive element Rs, a large resistance value is set for the resistive element Rs.

Therefore, the resistive element Rs restricts the flow of current from the common connection terminal T3 to ground through the resistive element Rs. Next, a description will be given of the normal diagnostic processing and self-diagnostic processing performed by the diagnostic circuit 40 in this embodiment.

First, the normal diagnostic processing will be described prior to the self-diagnostic processing. In this embodiment, it is assumed that the output voltage of the power source 2a and the output voltage of the power source 2b are different.

### Normal Diagnostic Processing

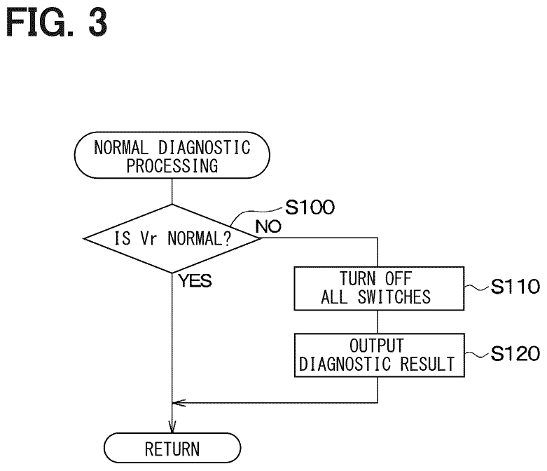

The diagnostic circuit 40 executes normal diagnostic processing in accordance with the flowchart shown in FIG. 3. The normal diagnostic processing is executed by the diagnostic circuit 40 during normal operation. The normal operation refers to the period during which power is supplied to the loads 3a to 3f, and includes, for example, when the activation switch that switches the vehicle to a drivable state is turned on.

First, as a third determination unit, the diagnostic circuit 40 detects the voltages V1, V2, and Vr in S100 with the switches SW1 and SW2 turned on, and determines whether the voltages V1, V2, and Vr are the same.

For example, when the output voltage of the power source 2a is higher than that of the power source 2b, and the switches SW1 and SW2 are normally turned on, the voltages V1, V2, and Vr are the same as the output voltage of the power source 2a.

At this time, in S100, the diagnostic circuit 40 determines YES if the voltages V1, V2, and Vr are the same, thereby determining that the conduction functions of the switches SW1 and SW2 are normal. The conduction function of the switch SW1 is a function that conducts between the common connection terminal T1 and the common connection terminal T3. The conduction function of switch SW2 is a function that conducts between the common connection terminal T2 and the common connection terminal T3.

For example, when the output voltage of the power source 2b is higher than that of the power source 2a, and the switches SW1 and SW2 are normally turned on, the voltages V1, V2, and Vr are the same as the output voltage of the power source 2b.

At this time, in S100, the diagnostic circuit 40 determines YES if the voltages V1, V2, and Vr are the same, thereby determining that the conduction functions of the switches SW1 and SW2 are normal.

For example, when the output voltage of the power source 2a and the output voltage of the power source 2b are different, and the switch SW1 is turned off due to a fault while the switch SW2 is normally turned on, the voltages V1 and Vr are not the same.

For example, when the output voltage of the power source 2a and the output voltage of the power source 2b are different, and the switch SW2 is turned off due to a fault while the switch SW1 is normally turned on, the voltages V2 and Vr are different.

For example, when the output voltage of the power source 2a and the output voltage of the power source 2b are different, and both the switches SW1 and SW2 are turned off due to faults, the voltages V1 and Vr are different, and the voltages V2 and Vr are different.

When at least one of voltage V1 or voltage V2 is different from the voltage Vr, the diagnostic circuit 40 determines NO in S100, determining that the conduction function of at least one of switches SW1 or SW2 is faulty.

At this time, the diagnostic circuit 40 turns off both the switches SW1 and SW2 in S110.

Next, in S120, the diagnostic circuit 40 outputs the diagnostic result (i.e., the diagnostic signal) indicating that the conduction function of at least one of the switches SW1 or SW2 is faulty, which was determined as NO in S100, to another electronic control unit.

### Self-Diagnosis Processing

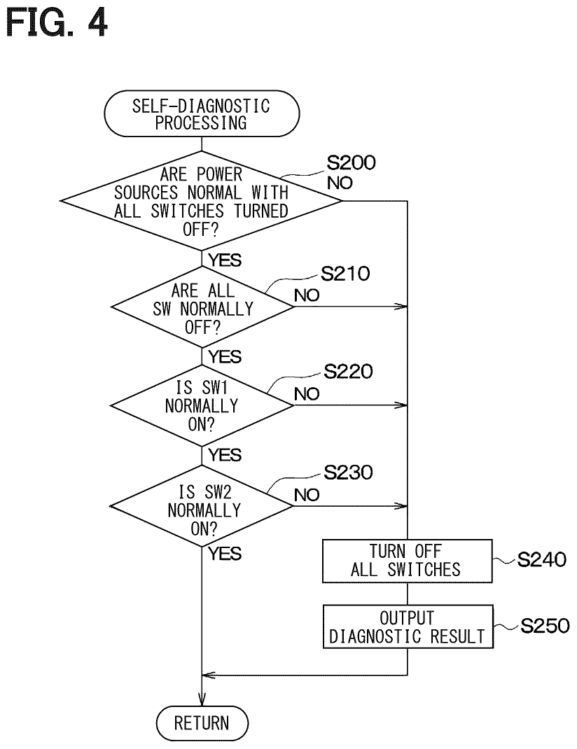

Next, the self-diagnosis processing will be explained with reference to FIG. 4. The diagnostic circuit 40 executes the self-diagnosis processing in accordance with the flowchart shown in FIG. 4. The self-diagnosis processing is executed by the diagnostic circuit 40, for example, when the vehicle is not being driven during normal operation.

First, in S200, the diagnostic circuit 40 detects the voltages V1 and V2 with the switches SW1 and SW2 turned off. At this time, the diagnostic circuit 40, as a fifth determination unit and a sixth determination unit, performs the following determinations (a) and (b) based on the voltages V1 and V2.
(a) As the fifth determination unit, the diagnostic circuit 40 determines whether the power source 2a is normal by determining whether the voltage V1 falls within a first predetermined range. At this time, in S200, the diagnostic circuit 40 determines that the power source 2a is normal if the voltage V1 falls within the first predetermined range. The first predetermined range is the range of voltage V1 that is expected when the power source 2a is in a normal state.
(b) As the sixth determination unit, the diagnostic circuit 40 determines whether the power source 2b is normal by determining whether the voltage V2 falls within a second predetermined range. At this time, in S200, the diagnostic circuit 40 determines that the power source 2b is normal if the voltage V2 falls within the second predetermined range. The second predetermined range is the range of voltage V1 that is expected when the power source 2b is in a normal state.

In S200, the diagnostic circuit 40 determines YES when both the voltage V1 falls within the first predetermined range and the voltage V2 falls within the second predetermined range, determining that the power sources 2a and 2b are each normal.

Next, as a fourth determination unit, in S210, the diagnostic circuit 40 detects the voltage Vr with the switches SW1 and SW2 turned off. At this time, the diagnostic circuit 40 determines whether the switches SW1 and SW2 are normally turned off by determining whether the voltage Vr is lower than the threshold value. For example, 0.5 V is set as the threshold value.

For example, when the switches SW1 and SW2 are both normally turned off, the voltage Vr becomes zero volt. In S210, the diagnostic circuit 40 determines YES if the voltage Vr is lower than the threshold value. As a result, it is determined that the cutoff functions of the switches SW1 and SW2 are operating normally.

The cutoff function of the switch SW1 is a function that cuts off the connection between the common connection terminal T1 and the common connection terminal T3. The cutoff function of the switch SW2 is a function that cuts off the connection between the common connection terminal T2 and the common connection terminal T3.

Next, as a first determination unit, the diagnostic circuit 40 detects the voltage V1 and the voltage Vr, respectively, in S220, with the switch SW1 turned on and the switch SW2 turned off. At this time, the diagnostic circuit 40 determines whether the conduction function of the switch SW1 is normal by determining whether the voltage V1 and the voltage Vr are the same.

At this time, in S220, when the diagnostic circuit 40 determines that the voltage V1 and the voltage Vr are the same, the diagnostic circuit 40 determines that the conduction function of the switch SW1 is normal and makes a YES determination.

Next, as a second determination unit, the diagnostic circuit 40 detects the voltage V2 and the voltage Vr, respectively, in the next S230, with the switch SW2 turned on and the switch SW1 turned off. At this time, the diagnostic circuit 40 determines whether the conduction function of the switch SW2 is normal by determining whether the voltage V2 and the voltage Vr are the same.

At this time, in S220, when the diagnostic circuit 40 determines that the voltage V2 and the voltage Vr are the same, the diagnostic circuit 40 determines that the conduction function of the switch SW2 is normal and makes a YES determination.

On the other hand, if the voltage V1 does not fall within the first predetermined range or if the voltage V2 does not fall within the second predetermined range in S200, a NO determination is made. For example, when a ground fault occurs in which the positive terminal of the high-voltage power supply is connected to the positive terminal of the power source 2a, the voltage V1 becomes greater than the first predetermined range. In this case, in S200, the diagnostic circuit 40 determines NO, determining that the power source 2a is faulty.

For example, when a ground fault occurs in which the positive terminal of the power source 2a is connected to ground, the voltage V1 becomes smaller than the first predetermined range. In this case, in S200, the diagnostic circuit 40 determines NO, determining that the power source 2a is faulty.

In S200, the diagnostic circuit 40 determines NO, determining that the power source 2a is faulty when the voltage V1 deviates from the first predetermined range. Accordingly, in S240, the diagnostic circuit 40 turns off the switches SW1 and SW2.

Next, in S250, the diagnostic circuit 40 determines that the power source 2a is faulty and outputs the diagnosis result of the NO determination in S200 to the other electronic control units.

Similarly, for example, if a ground fault occurs in which the positive terminal o the high-voltage power supply is connected to the positive terminal of the power source 2b, the voltage V2 becomes greater than the second predetermined range. In this case, in S200, the diagnostic circuit 40 determines NO, determining that the power source 2b is faulty.

For example, if a ground fault occurs in which the positive terminal of the power source 2b is connected to ground, the voltage V2 becomes lower than the second predetermined range. In this case, in S200, the diagnostic circuit 40 determines NO, determining that the power source 2b is faulty.

In S200, the diagnostic circuit 40 determines NO, determining that the power source 2b is faulty when the voltage V2 deviates from the first predetermined range. Accordingly, in S240, the diagnostic circuit 40 turns off the switches SW1 and SW2.

Next, in S250, the diagnostic circuit 40 determines that the power source 2b is faulty and outputs the diagnosis result of the NO determination in S200 to the other electronic control units.

Also, in S210, when the diagnostic circuit 40 has turned off the switches SW1 and SW2, but the switch SW1 of the switches SW1 and SW2 remains being turned on due to a fault, the voltage Vr becomes equal to or greater than the threshold value.

When the diagnostic circuit 40 has turned off the switches SW1 and SW2, but the switch SW2 of the switches SW1 and SW2 remains being turned on due to a fault, the voltage Vr becomes equal to or higher than the threshold value.

Even though the diagnostic circuit 40 has turned off switches SW1 and SW2, if both switches SW1 and SW2 remain being turned on due to faults, the voltage Vr becomes equal to or greater than the threshold value.

In S210, when the voltage Vr is equal to or greater than the threshold value, the diagnostic circuit 40 determines NO, considering that at least one of the cutoff functions of the switches SW1 or SW2 is faulty. Accordingly, in S240, the diagnostic circuit 40 turns off the switches SW1 and SW2.

Next, in S250, the diagnostic circuit 40 outputs to another electronic control unit the diagnostic result determined as NO in S210, indicating that at least one of the cutoff functions of switches SW1 or SW2 is faulty.

In addition, in S220, even though the switch SW1 is turned on and the switch SW2 is turned off, if the switch SW1 turns off due to a fault, the voltage Vr becomes zero volt. In this case, in S220, the diagnostic circuit 40 determines NO, considering that the conduction function of the switch SW1 is faulty, since the voltage V1 and the voltage Vr are different.

Accordingly, in S240, the diagnostic circuit 40 turns off the switches SW1 and SW2. Next, in S250, the diagnostic circuit 40 outputs to another electronic control unit the diagnostic result determined as NO in S220, indicating that the conduction function of switch SW1 is faulty.

Furthermore, in S230, even though the switch SW2 is turned on and the switch SW1 is turned off, if the switch SW2 turns off due to a fault, the voltage Vr becomes zero volt. In this case, in S220, the diagnostic circuit 40 determines NO, considering that the conduction function of the switch SW2 has a fault, since the voltage V2 and the voltage Vr are different.

Accordingly, in S240, the diagnostic circuit 40 turns off the switches SW1 and SW2. Next, in S250, the diagnostic circuit 40 outputs to another electronic control unit the diagnostic result determined as NO in S230, indicating that the conduction function of the switch SW2 is faulty.

According to the embodiment described above, the electronic control unit 5 includes the system conductor 30 that supplies power output from the power source 2a to the loads 3a, 3b, and 3c, and the system conductor 31 that supplies power output from the power source 2b to the loads 3d, 3e, and 3f.

The electronic control unit 5 includes the inter-system conductor 32, which is disposed between the system conductors 30 and 31. The inter-system conductor 32 supplies power from the power source 2a to the loads 3d, 3e, and 3f through the system conductor 30, or supplies power from the power source 2b to the loads 3a, 3b, and 3c through the system conductor 31.

The electronic control unit 5 includes the switch SW1, which is disposed between the system conductors 30 and 31. The switch SW1 is turned on to conduct the current flowing through the current flowing through the inter-system conductor 32, and is turned off to cut off the current flowing through the inter-system conductor 32. The electronic control unit 5 includes the switch SW2, which is disposed between the system conductors 30 and 31 and connected in series with the switch SW1. The switch SW2 is turned on to conduct the current flowing through the current flowing through the inter-system conductor 32, and is turned off to cut off the current flowing through the inter-system conductor 32.

The electronic control unit 5 includes the resistive element Rs, which is connected between the common connection terminal T3 and ground. The common connection terminal is a terminal to which both the switches SW1 and SW2 are commonly connected.

The voltage between the system conductor 30 and ground is defined as voltage V1, the voltage between the system conductor 31 and ground is defined as voltage V2, and the voltage between the common connection terminal T3 and ground is defined as voltage Vr.

The electronic control unit 5 has S220 in which, with the switch SW1 turned o and the switch SW2 turned off, the electronic control unit 5 determines whether the voltage V1 and the voltage Vr are different, and determines whether the switch SW1 is being turned off due to a fault.

The electronic control unit 5 includes S230 in which, with the switch SW2 turned on and the switch SW1 turned off, the electronic control unit 5 determines whether the voltage V2 and the voltage Vr are inconsistent, and thereby determines whether the switch SW2 is turned off due to a fault.

The electronic control unit 5 includes S100 in which, with both the switches SW1 and SW2 turned on, the electronic control unit 5 determines whether at least one of the voltages V1 or V2 is different from the voltage Vr.

In S100, by determining whether at least one of the voltages V1 or V2 is different from the voltage Vr, it is determined whether at least one of the switches SW1 or SW2 is being turned off due to a fault.

As described above, the electronic control unit 5 can determine, based on the voltages V1, V2, and Vr, whether the conduction function of the switches SW1 and SW2 is faulty.

The electronic control unit 5 has S210 in which, with the switches SW1 and SW2 turned off, the electronic control unit determines whether the voltage Vr is equal to or greater than a threshold value, thereby determining whether at least one of the switches SW1 and SW2 is being turned on due to a fault.

As described above, the electronic control unit 5 can determine, based on voltage Vr, whether the cutoff function of the switches SW1 and SW2 is faulty.

In this embodiment, as described above, the resistive element Rs is connected between the common connection terminal T3 and ground. At this time, the inter-system conductor 32 supplies the power output from the power source 2a through the system conductor 30 to the loads 3d, 3e, and 3f, or supplies the power output from the power source 2b through the system conductor 31 to the loads 3a, 3b, and 3c.

The resistive element Rs serves the function of bringing the potential of the common connection terminal T3 to the same potential as ground when the switches SW1 and SW2 are turned off. According to the present embodiment described above, it is possible to provide an electronic control unit 5 that performs fault diagnosis of the switches SW1 and SW2 without detecting current using a resistive element.

In this embodiment, the diagnostic circuit 40 determines whether the power source 2a is faulty by determining whether the voltage V1 is outside the first predetermined range. As a result, diagnosis of the power source 2a can be carried out effectively.

In this embodiment, the diagnostic circuit 40 determines whether the power source 2b is faulty by determining whether the voltage V2 is outside the second predetermined range. As a result, diagnosis of the power source 2b can be carried out effectively.

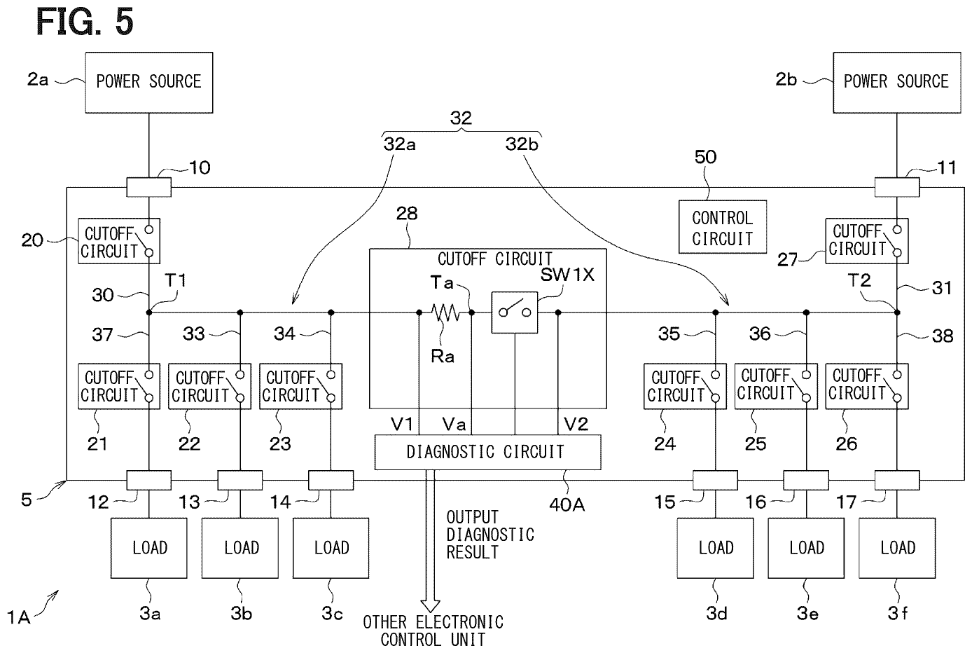

In addition, in the in-vehicle power supply system 1A in the first comparative example shown in FIG. 5, the electronic control unit 5 includes a switch SW1X as a substitute for the switches SW1 and SW2, the resistive element Ra for current detection, and a diagnostic circuit 40A as a substitute for the diagnostic circuit 40.

The switch SW1X is disposed between system conductors 30 and 31, and is turned on to conduct the current flowing through the inter-system conductor 32, and is turned off to cut off the current flowing through the inter-system conductor 32. The resistive element Ra is connected in series with the switch SW1X between the system conductors 30 and 31.

The voltage between the system conductor 30 and ground is defined as voltage V1, and the voltage between the system conductor 31 and ground is defined as voltage V2. The voltage between the common connection terminal Ta and ground is defined as voltage Va. The common connection terminal Ta is a terminal to which both the resistive element Ra and the switch SW1X are commonly connected.

The diagnostic circuit 40A determines whether the switch SW1X is normally turned off by determining whether or not the voltage Va and the voltage V2 are different, with the switch SW1X is turned off.

The diagnostic circuit 40A detects the voltage V1 and the voltage Va with the switch SW1X turned off, and determines the current flowing through the resistive element Ra based on the voltage V1 and the voltage Va. The diagnostic circuit 40A determines whether the switch SW1X is normally turned on by determining whether the current flowing through the resistive element Ra is equal to or greater than a threshold value.

In this case, if a large current flows through the resistive element Ra with the switch SW1X turned on, a large amount of heat will be generated from the resistive element Ra. Therefore, it is necessary to enhance the heat dissipation performance of the resistive element Ra and, by extension, the cutoff circuit 28.

In contrast, in the present embodiment, as described above, current detection using a resistive element is not performed. Therefore, it is not necessary to enhance the heat dissipation performance of the resistive element Rs, and by extension, the cutoff circuit 28.

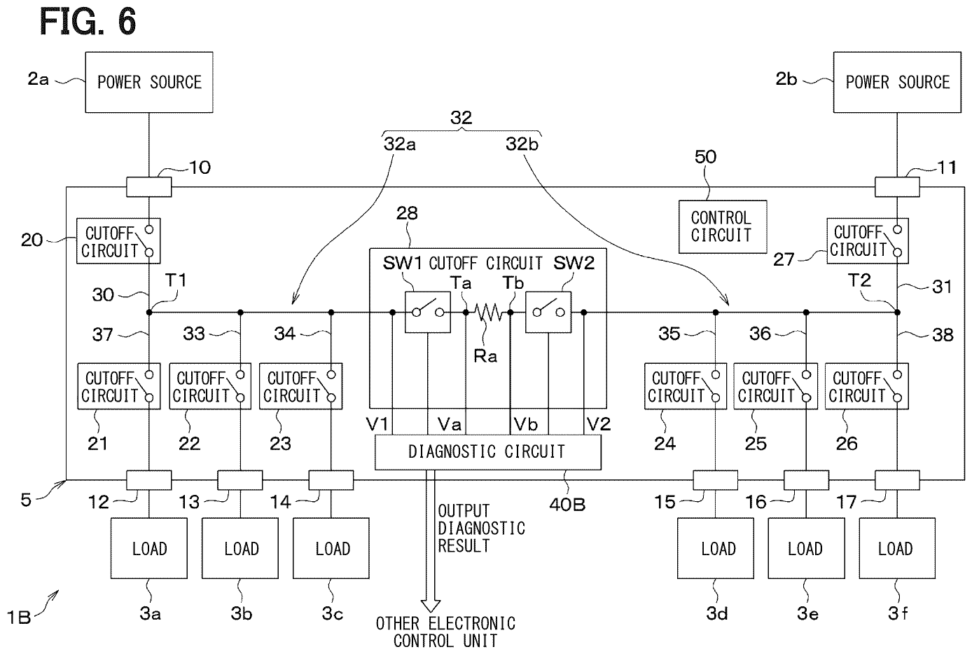

Furthermore, in the in-vehicle power supply system 1B of the second comparative example shown in FIG. 6, the electronic control unit 5 includes a resistive element Ra for current detection and a diagnostic circuit 40B in place of the diagnostic circuit 40.

The resistive element Ra is connected between the switch SW1 and the switch SW2. The resistive element Ra is connected in series with the switches SW1 and SW2 between the system conductors 30 and 31.

The voltage between the system conductor 30 and ground is defined as voltage V1, and the voltage between the system conductor 31 and ground is defined as voltage V2. The voltage between the common connection terminal Ta and ground is defined as voltage Va.

The common connection terminal Ta is a terminal to which both the resistive element Ra and the switch SW1 are commonly connected. The voltage between the common connection terminal Tb and ground is defined as voltage Vb. The common connection terminal Tb is a terminal to which both the resistive element Ra and the switch SW2 are commonly connected.

The diagnostic circuit 40B, in order to determine whether the switches SW1 and SW2 are normally turned on, detects the voltage Va and the voltage Vb with the switches SW1 and SW2 turned on, and calculates the current flowing through the resistive element Ra based on the voltage Va and the voltage Vb.

At this time, the diagnostic circuit 40B can determine whether the switches SW1 and SW2 are normally turned on by determining whether the current flowing through the resistive element Ra is equal to or greater than a threshold value.

To diagnose a fault in the switch SW1, the diagnostic circuit 40B detects the voltages Va and Vb with the cutoff circuit 20 turned off, the switch SW1 turned off, and the switch SW2 turned on.

At this time, the diagnostic circuit 40B determines the magnitude of the current flowing through the resistive element Ra based on the voltages Va and Vb, as well as the direction along which this current flows. The diagnostic circuit 40B determines whether the magnitude of the current flowing through the resistive element Ra from the common connection terminal Tb to the common connection terminal Ta is equal to or greater than a threshold value.

By this means, it is possible to determine whether the switch SW1 is turned o due to a fault. That is, the diagnostic circuit 40B can determine, based on the current flowing through the resistive element Ra, whether the switch SW1 is normally turned off or not.

In this case, since the cutoff circuit 20 is turned off, it is possible to diagnose a fault of the switch SW1 regardless of the output voltage of the power source 2a. However, since the cutoff circuit 20 is turned off, electric power is no longer supplied from the power source 2a to the loads 3a, 3b, and 3c.

In contrast, in this embodiment, the diagnostic circuit 40 determines whether the switch SW1 is normally off by determining whether the voltage Vr is less than the threshold value when the switches SW1 and SW2 are in the off state.

Therefore, in the present embodiment, it is not necessary to turn off the cutoff circuit 20 when performing the fault diagnosis of the switch SW1. Accordingly, when performing the fault diagnosis of the switch SW1, it is possible to supply electric power from the power source 2a to the loads 3a, 3b, and 3c.

To diagnose a fault in the switch SW2, the diagnostic circuit 40B detects the voltages Va and Vb with the cutoff circuit 27 turned off, the switch SW2 turned off, and the switch SW1 turned on.

At this time, the diagnostic circuit 40B determines the magnitude of the current flowing through the resistive element Ra based on the voltages Va and Vb, as well as the direction along which this current flows. The diagnostic circuit 40B determines whether the magnitude of the current flowing from the common connection terminal Ta to the common connection terminal Tb through the resistive element Ra is equal to or greater than a threshold value.

By this means, it is possible to determine whether the switch SW2 is turned o due to a fault. That is, the diagnostic circuit 40B can determine whether the switch SW2 is normally turned off or not based on the current flowing through the resistive element Ra.

In this case, since the cutoff circuit 27 is turned off, it is possible to diagnose a fault of the switch SW2 regardless of the output voltage of the power source 2b. However, since the cutoff circuit 27 is turned off, power will no longer be supplied from the power source 2b to the loads 3d, 3e, and 3f.

In contrast, in the present embodiment, the diagnostic circuit 40 determines whether the switches SW1 and SW2 are normally turned off by determining whether the voltage Vr is below the threshold value while both switches SW1 and SW2 are in the off state.

Therefore, in the present embodiment, it is not necessary to turn off the cutoff circuit 27 in order to diagnose a fault of the switch SW2. Accordingly, when diagnosing a failure of the switch SW2, it is possible to supply power from the power source 2b to the loads 3d, 3e, and 3f.

### Other Embodiments

(a) In the above embodiment, an example was described in which the power distribution device of the present disclosure is applied to the in-vehicle power supply system 1; however, instead, the power distribution device of the present disclosure may be applied to a stationary power supply system 1.
(b) In the above embodiment, an example was described in which the diagnostic circuit 40 executes the determination process in S200, which determines whether the power sources 2a and 2b have a fault, during the self-diagnosis processing.

However, alternatively, the diagnostic circuit 40 may execute the determination process of S200, which determines whether the power sources 2a and 2b have a fault, during the normal diagnostic processing.
(c) It should be noted that the present disclosure is not limited to the embodiments described above, and various modifications may be made as appropriate within the scope described in the present disclosure. Furthermore, the above embodiments are not mutually exclusive, and may be appropriately combined unless such combinations are clearly impossible. Moreover, in each of the above embodiments, it goes without saying that the constituent elements of the embodiments are not necessarily essential unless explicitly stated as essential or considered to be clearly essential in principle. Furthermore, in each of the above embodiments, when quantitative values such as the number, numerical value, amount, or range of constituent elements are mentioned, such values are not limited to those specific numbers unless explicitly stated as essential or unless it is clearly limited to a specific number in principle. Furthermore, in each of the above embodiments, when referring to the shape, positional relationship, or the like of constituent elements, such shape or positional relationship is not limited thereto unless explicitly specified or unless it is clearly limited to a particular shape or positional relationship in principle.

What is claimed is:

1. A power distribution device comprising:
a first system conductor configured to supply power output from a first power source to a first load;
a second system conductor configured to supply power output from a second power source to a second load;
an inter-system conductor located between the first system conductor and the second system conductor, the inter-system conductor configured to
supply power output from the first power source through the first system conductor to the second load, or
supply power output from the second power source through the second system conductor to the first load;
a first switch located between the first system conductor and the second system conductor, the first switch configured to be
turned on to conduct current flowing through the inter-system conductor, and
turned off to cut off the current flowing through the inter-system conductor;
a second switch located between the first system conductor and the second system conductor, the second switch being connected in series with the first switch, the second switch configured to be
turned on to conduct the current flowing through the inter-system conductor, and
turned off to cut off the current flowing through the inter-system conductor;
a resistive element connected between a ground and a common connection terminal to which the first switch and the second switch are commonly connected; and
a circuit configured to, where a first voltage is a voltage between the first system conductor and the ground, a second voltage is a voltage between the second system conductor and the ground, and a third voltage is a voltage between the common connection terminal and the ground,
determine whether a conduction function of the first switch is faulty based on whether the first voltage differs from the third voltage, when the first switch is turned on and the second switch is turned off,
determine whether a conduction function of the second switch is faulty based on whether the second voltage differs from the third voltage, when the first switch is turned off and the second switch is turned on,
determine whether the conduction function of at least one of the first switch or the second switch is faulty based on whether at least one of the first voltage or the second voltage differs from the third voltage, when the first switch and the second switch are turned on, and
determine whether a cutoff function of at least one of the first switch or the second switch is faulty based on whether the third voltage is at least a threshold value, when the first switch and the second switch are turned off.

2. The power distribution device according to claim 1, wherein
the circuit is further configured to determine whether the first power source is faulty based on whether the first voltage is outside a first predetermined range.

3. The power distribution device according to claim 1, wherein
the circuit is further configured to determine whether the second power source is faulty based on whether the second voltage is outside a second predetermined range.
